(19) United States
(12) Patent Application Publication
(10) Pub. No.: US 2025/0036649 A1
(43) Pub. Date: Jan. 30, 2025

(54) SYSTEMS AND METHODS FOR IDENTIFICATION AND VISUALIZATION OF DATABASE OBJECT RELATIONSHIPS AND THEIR IMPACT ON STORAGE COSTS

(71) Applicant: JPMORGAN CHASE BANK, N.A., New York, NY (US)

(72) Inventors: Ross MILLAR, New York, NY (US); Diarmuid MOLONEY, London (GB)

(21) Appl. No.: 18/358,680

(22) Filed: Jul. 25, 2023

(51) Int. Cl. G06F 16/26; G06F 11/34; G06F 16/21; G06F 16/22

(52) U.S. Cl. CPC G06F 16/26; G06F 11/3409; G06F 16/21; G06F 16/2282

(57) ABSTRACT

A method for identification of database object relationships and their impact on storage costs may include: (1) retrieving, by a data management computer program, metadata for an allocation of data to a physical storage media; (2) determining, by the data management computer program and based on the metadata, an amount of physical storage used; (3) identifying, by the data management computer program, relationships between data objects in the data by parsing SQLs from the data objects in the allocation of data; (4) determining, by the data management computer program, an impact of the relationships on a data movement process; and (5) providing, by the data management computer program, a recommendation for reducing physical storage based on the amount of physical storage used, an amount of physical storage allocated, and an impact of the relationships on the data movement process.

### BACKGROUND OF THE INVENTION

### 1. Field of the Invention

Embodiments generally relate to systems and methods for identification and visualization of database object relationships and their impact on storage costs.

### 2. Description of the Related Art

Historically, understanding the allocation of storage within a database requires a Subject Matter Expert (SME) to interpret how storage is allocated. This makes it difficult for non-SME Software Developers to understand how storage is used and where there are potential savings and archiving opportunities. This stems from existing tooling being focused on the role of the Database Administrator rather than the Software Developer.

Application Developers and Database Administrators (DBAs) typically have different technology perspectives on the database, so tooling is needed to help the Application Developer have a similar understanding to the DBA. This lack of understanding also adds tension to financial discussions as the Application Developers struggle to explain both the size and cost of Production Databases, as the cost directly translates to an understanding of how the storage is structured.

In addition, to fully understand the scope and complexity of storage management, the relationships between data need to be understood at the application layer, and not just the structural database layer. In practice, this means that we must look at the views, triggers, SQL statements that are executed to be able to understand how the data is related from a usage perspective in addition to the already known structural relationships.

### SUMMARY OF THE INVENTION

Systems and methods for identification and visualization of database object relationships and their impact on storage costs are disclosed. According to an embodiment, a method for identification of database object relationships and their impact on storage costs may include: (1) retrieving, by a data management computer program, metadata for an allocation of data to a physical storage media; (2) determining, by the data management computer program and based on the metadata, an amount of physical storage used; (3) identifying, by the data management computer program, relationships between data objects in the data by parsing SQLs from the data objects in the allocation of data; (4) determining, by the data management computer program, an impact of the relationships on a data movement process; and (5) providing, by the data management computer program, a recommendation for reducing physical storage based on the amount of physical storage used, an amount of physical storage allocated, and an impact of the relationships on the data movement process.

In one embodiment, the physical storage media may include logical storage.

In one embodiment, the method may also include determining, by the data management computer program, a storage cost for the physical storage used to store the data using a cost overlay, wherein the recommendation for reducing physical storage may be further based on the storage cost. In one embodiment, the cost overlay identifies storage costs for different storage capabilities.

In one embodiment, the method may also include determining, by the data management computer program, a time to recover the data on the physical storage media, wherein the time to recover may be based on a volume of data on the physical storage media, network speeds and a read speed and a write speed of the physical storage media.

In one embodiment, the method may also include: determining, by the data management computer program, a type of data on the physical storage media; and identifying, by the data management computer program, data in the allocation of data on the physical storage media to move off of the physical storage media based on the type of data.

In one embodiment, the recommendation for reducing physical storage may be further based on the identification of the data to move off the physical storage.

In one embodiment, the method may also include graphically presenting, by the data management computer program, the physical storage used versus an allocated amount of physical storage.

In one embodiment, the method may also include graphically presenting, by the data management computer program, the relationships between data objects as a dependency graph.

According to another embodiment, a system may include: a physical storage media storing an allocation of data; and an electronic device executing a data management computer program that retrieves metadata for the allocation of data to a physical storage media, determines an amount of physical storage used from the metadata, identifying relationships between data objects in the data by parsing SQLs from the data objects in the allocation of data, determines an impact of the relationships on a data movement process, and providing a recommendation for reducing physical storage based on the amount of physical storage used, an amount of physical storage allocated, and an impact of the relationships on the data movement process.

In one embodiment, the data management computer program further determines a storage cost for the physical storage used to store the data using a cost overlay, and the recommendation for reducing physical storage may be further based on the storage cost. In one embodiment, the cost overlay may identify storage costs for different storage capabilities.

In one embodiment, the data management computer program further determines a time to recover the data on the physical storage media, wherein the time to recover may be based on a volume of data on the physical storage media, network speeds and a read speed and a write speed of the physical storage media.

In one embodiment, the data management computer program further determines a type of data on the physical storage media and identifies data in the allocation of data on the physical storage media to move off of the physical storage media based on the type of data.

In one embodiment, the recommendation for reducing physical storage may be further based on the identification of the data to move off the physical storage.

In one embodiment, the data management computer program further graphically presents the physical storage used versus an allocated amount of physical storage.

In one embodiment, the data management computer program further graphically presents the relationships between data objects as a dependency graph.

According to another embodiment, a non-transitory computer readable storage medium, may include instructions stored thereon, which when read and executed by one or more computer processors, cause the one or more computer processors to perform steps including: retrieving, by a data management computer program, metadata for an allocation of data to a physical storage media; determining, based on the metadata, an amount of physical storage used; identifying relationships between data objects in the data by parsing SQLs from the data objects in the allocation of data; determining an impact of the relationships on a data movement process; providing a recommendation for reducing physical storage based on the amount of physical storage used, an amount of physical storage allocated, and an impact of the relationships on the data movement process; and graphically presenting, by the data management computer program, the physical storage used versus an allocated amount of physical storage and the relationships between data objects as a dependency graph.

In one embodiment, the non-transitory computer readable storage medium may also include instructions stored thereon, which when read and executed by one or more computer processors, cause the one or more computer processors to determine a storage cost for the physical storage used to store the data, wherein the recommendation for reducing physical storage may be further based on the storage cost.

In one embodiment, the non-transitory computer readable storage medium may also include instructions stored thereon, which when read and executed by one or more computer processors, cause the one or more computer processors to determine a type of data on the physical storage media; and identify data in the allocation of data on the physical storage media to move off of the physical storage media based on the type of data, wherein the recommendation for reducing physical storage may be further based on the identification of the data to move off the physical storage.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for identification and visualization of database object relationships and their impact on storage costs according to an embodiment;

FIG. 2 illustrates a method for identification and visualization of database object relationships and their impact on storage costs according to an embodiment;

FIG. 3 depicts an exemplary computing system for implementing aspects of the present disclosure.

### DETAILED DESCRIPTION OF PREFERRED EMBODIMENTS

Embodiments are directed to systems and methods for identification and visualization of database object relationships and their impact on storage costs.

Embodiments may present a visual story of storage, from the physical disk that is purchased down to the level of data stored on that disk. This may require the extraction of available database metadata from vendor databases, and then presenting that data in a manner that helps the typical software development team understand their database. For example, starting with the presentation of the data from a physical perspective (e.g., at the storage media level), embodiments may “drill-down” from the physical layer to the logical layer to the actual underlying database tables. At the detailed level of storage, embodiments may present information to the application developer with the database “table” as the main point of presentation and may correlate related table data, indexes and binary data at that level. This view may be overlayed with the actual underlying dollar cost of storing that logical entity. A directed graph illustrating the complexity of all relationships between the structural and code parts of the database may be provided.

Next, the relationships between SQL objects may be determined by parsing database views, stored procedures, functions, triggers, select statements, etc. and generating a sequence of events that correspond to the database operations, such as create, read, update, and delete.

Based on the identified relationships and understanding of database size, embodiments may generate and provide recommendations on archiving policies and data retention with a view to cost savings. This has applications for the realm of the public cloud, where there are a wider variety of archiving solutions available.

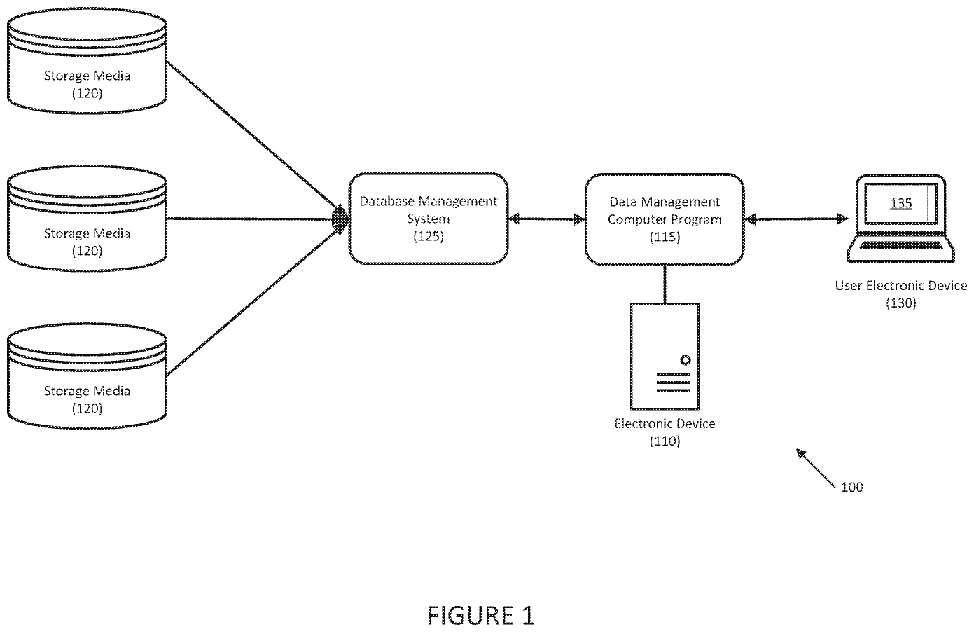

Referring to FIG. 1, a system for identification and visualization of database object relationships and their impact on storage costs is disclosed according to an embodiment. System 100 may include electronic device 110, which may be a server (e.g., physical and/or cloud-based), a computer (e.g., workstation, desktop, laptop, notebook, tablet, etc.,), etc. Electronic device 110 may execute data management computer program 115, which may interface with a plurality of storage media 120, such a physical storage. Storage media 120 may store databases, and may interface with data management computer program 115 via, for example, database management system 125. DBMS 125 may provide data regarding how storage media 120 are used, including the use of physical and logical storage.

Storage media 120 may store data for a plurality of users.

System 100 may also include user electronic device 130, which may be a computer, a smart device (e.g., smart phone, smart watch, etc.), an Internet of Things (IoT) appliance, etc. User electronic device 130 may execute user computer program 135, which may interface with data management computer program 115. For example, data management computer program 115 may be a distributed application, and may include user computer program 135.

In another embodiment, user computer program 135 may be a browser or similar that may access data management computer program 115 over a network connection.

Data management computer program 115 may determine, on an application-by-application basis, on a user-by-user basis, on a group-by-group basis, on a tenant-by-tenant basis, etc. how much physical storage the application, user, group, or tenant is using, the type of data that is being stored, any relationships among the stored data, the cost of the data storage, the amount of physical storage used versus the physical storage allocated, etc. In one embodiment, data management computer program 115 may provide a graphical representation of the use, costs, etc. and may provide recommendations on how to reduce the amount of physical storage used. It may also illustrate the impact on all data, objects, programs, etc. of deleting certain data.

Data management computer program 115 may also determine one or more paths for restructuring a database based on the data relationships identified. This may allow large databases to be refactored into smaller footprints.

Data management computer program 115 may also identify potentially redundant copies of data objects using, for example, a process of learning and matching typical naming conventions for redundant copies.

In one embodiment, data management computer program 115 may use a matching process, whereby table names and a set of known suffixes/prefixes for the tables may be matched. For example, a table named XYZ_BKUP_20230301 is very likely a backup copy of data based on the BKUP in the name and the prefix of a string that looks like a date.

In one embodiment, machine learning provides potential for the system “learning” and discovering the different conventions, or not, that developers use to denote backups or copies of data.

Data management computer program 115 may also determine best practice archival strategies based on the identification of data relationships. In other words, data management computer program 115 may consider the impact of the relationships that come from data use in order to determine archival policies for the data. For example, if there is a relationship on the reading of data between TableA and TableB, where the data is joined in an SQL Select statement to produce a result, the archival policy would be selected so that it does not prevent that that Select statement from correctly producing data.

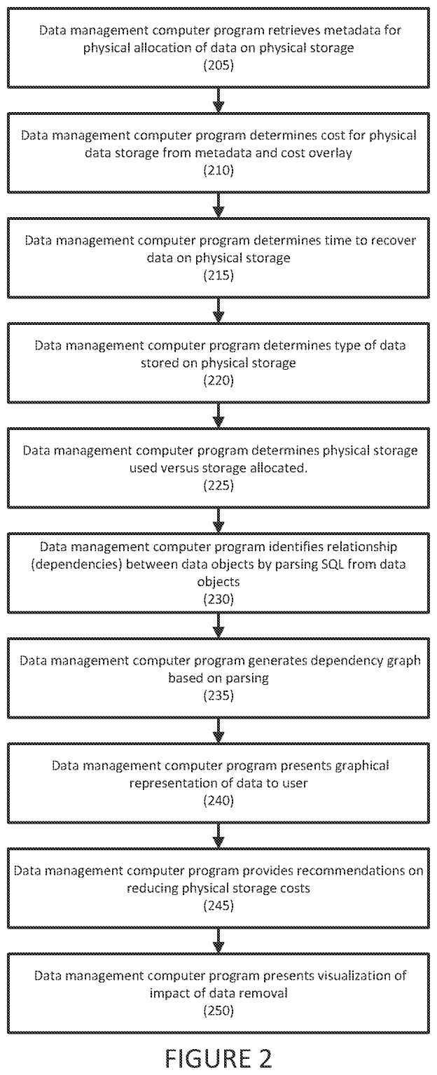

Referring to FIG. 2, a method for identification and visualization of database object relationships and their impact on storage costs is disclosed according to an embodiment.

In step 205, a data management computer program may retrieve metadata for a physical allocation of data to a DBMS on a plurality of storage media. An example of storage media may include physical storage devices, such as physical disks.

In step 210, the data management computer program may determine a cost for the physical data storage that is being used from the metadata and by using a cost overlay. For example, an organization may use its cost overlay for the costs associated with different levels of storage.

In embodiments, the cost may be a value that may be associated with different levels of storage, such as an amount that an organization or a third party may charge for different types of storage with different capabilities. The levels of storage may be based on, for example, performance, replication capabilities, location, etc. Examples of storage levels may include production environment high performance, multi-site replication, test environment high performance, no replication capability, etc.

The storage levels may also map to storage tiers provided by external providers, such as cloud providers.

In step 215, the data management computer program may determine a time to recover data on the physical storage devices in the event of a physical storage device failure. This may include determining the volume of data on the storage media, network speeds, read and write speed of the storage media, etc.

In one embodiment, the determination may be a mathematical operation that may be based on the specific setup of the database DBMS, and generally determined by dividing the size of the data to be restored by the speed of the DBMS restore. The speed of DBMS restore may be based on, for example, both the network speed and the DBMS vendor restore capability. The DBMS vendor restore capability may be based on a service level agreement provided by the DBMS vendor.

In step 220, the data management computer program may determine a type of data stored on the storage media. For example, embodiments may determine the type of data, and, as necessary, recommend potentially different technologies to use to store the data.

Different characterizations of the data type may be used to “tune” the archival recommendations and help the developers determine how they are using their DBMS storage in a way that makes sense to them. For example, data may be characterized as “basic data” (which is the majority of data and the starting point for most of the analysis). Next is “index data,” which includes fast lookup data that is generated based on the basic data. Index data may be managed separately from a backup perspective. Embodiments may also provide analysis into the potential overuse or sub-optimal creation of indexes that influence the cost of storage.

For example, if the data type is binary data (which is typically file based), it may make sense to move the binary data out of the DBMS and into an on-premise or cloud based object storage solution because these are generally cheaper places to store binary data. Thus, moving the binary data into the object store and updating the application may result in significant cost savings.

In step 225, the data management computer program may determine the amount of storage media used versus an amount of storage allocated to the underlying DBMS, logical storage, etc. This may be presented to the user to provide an understanding as to how much physical data storage is being used versus how much physical storage is being paid for.

For example, the DBMS may initially be allocated 10 TB of physical storage. After analysis, the data management computer program may determine that only using 100 GB of the allocated space is actually being used.

Similarly, the physical storage may be sub-divided into logical storage areas, which may have a similar issue. For example, a logical region may be allocated 1 TB of the 10 TB, but the data management computer program may determine that only 50 GB of the allocated 1 TB is being used.

Thus, embodiments may allow the developer to “drill down” from physical storage to logical storage areas, from a logical storage area to tables within a logical storage area, and from the table to binary data within the table.

In step 230, the data management computer program may identify relationships, such as dependencies, between data objects on the storage media. This may be done by parsing SQLs from the data objects. In one embodiment, the data management computer program may identify database tables and determine the dependent relationships between the tables. The relationships may be constructed by identifying any SQL statements passed into the database from either external interaction with the database system or maintained within the database as “Stored Procedures” or any other type of Stored Programmable Construct and passing these through an SQL Parser Process.

In one embodiment, potential archiving solutions may be based on the relationships between the data objects and the storage media. For example, if the data type is binary data, and there are no relationships identified, then data management computer program may recommend moving the binary data to an Archiving Object Store which is typically cheaper than a DBMS or Object Store.

Thus, embodiments may also analyze legacy design patterns for data storage and make recommendations based on newer storage technology approaches available.

In step 235, using the output of the SQL parser, the data management computer program may construct a dependency graph of all database objects used (e.g., a table, a procedure) along with the action applied (e.g., create, read, update, delete). Thus, the output of the SQL parser may be used to identify relationships between the tables.

These relationships between the data objects and the action applied may then be used to analyze the storage use for each table in order to determine the impact of any archiving process. For example, the relationships may identify the impact on a second table of deleting data from a first table.

In step 240, the data management computer program may present a graphical representation of data to the user. The graphical representation may present the data at different levels (e.g., user, group, tenant, application, organization, etc.) and may identify dependencies among the data.

In step 245, the data management computer program may provide recommendations on how to reduce storage costs, such as physical storage costs.

In embodiments, the recommendation may be based on the amount of physical storage used and the amount of physical storage that is being paid for. For example, if 200 GB is allocated, and only 20 GB is used, the data management computer program may recommend reducing the amount of physical storage that is allocated.

In embodiments, the recommendation may also be based on recommended data movement, such as recommended data movement to the cloud, archival storage, etc.

In step 250, the data management computer program may present a visualization of impact of data removal. For example, the data management computer program may identify data to be removed and identify impacted applications, objects, users, etc.

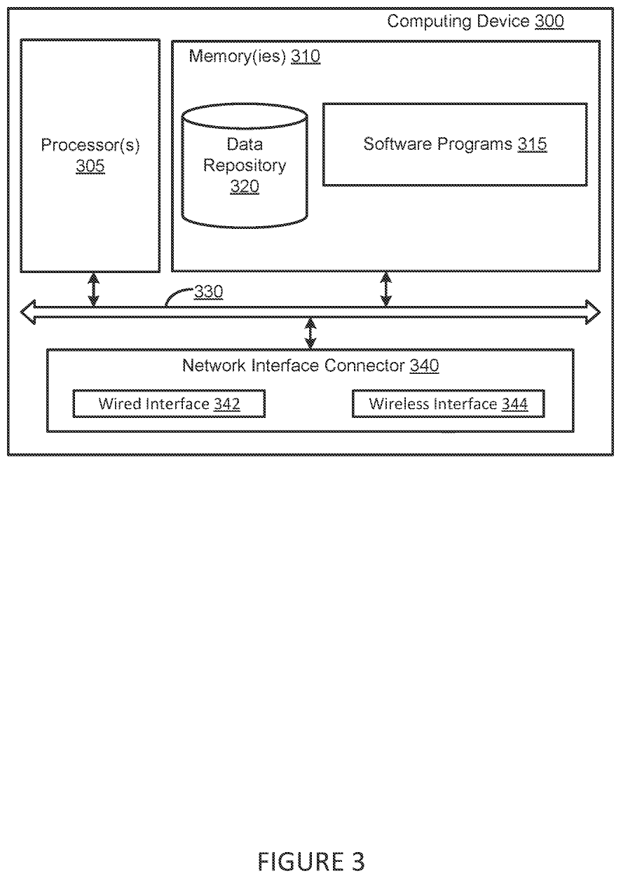

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for identification of database object relationships and their impact on storage costs, comprising:
retrieving, by a data management computer program, metadata for an allocation of data to a physical storage media;
determining, by the data management computer program and based on the metadata, an amount of physical storage used;
identifying, by the data management computer program, relationships between data objects in the data by parsing SQL statements directed towards the data objects in the allocation of data;
generating, by the data management computer program, a dependency graph using the relationships between data objects;
identifying, by the data management computer program, data to be removed as part of a data archival process;
analyzing, by the data management computer program, an impact of the data to be removed on the relationships using the dependency graph;
providing a recommendation for reducing physical storage based on the amount of physical storage used, an amount of physical storage allocated, and the impact of the data to be removed;
graphically presenting, by the data management computer program, the physical storage used versus an allocated amount of physical storage and the relationships between data objects using the dependency graph; and
presenting, by the data management computer program, a visualization of the impact of the data to be removed.

2. The method of claim 1, wherein the physical storage media comprises logical storage.

3. The method of claim 1, further comprising:
determining, by the data management computer program, a storage cost for the physical storage used to store the data using a cost overlay;
wherein the recommendation for reducing physical storage is further based on the storage cost.

4. The method of claim 3, wherein the cost overlay identifies storage costs for different storage capabilities.

5. The method of claim 1, further comprising:
determining, by the data management computer program, a time to recover the data on the physical storage media, wherein the time to recover is based on a volume of data on the physical storage media, network speeds and a read speed and a write speed of the physical storage media.

6. The method of claim 1, further comprising:
determining, by the data management computer program, a type of data on the physical storage media; and
identifying, by the data management computer program, data in the allocation of data on the physical storage media to move off of the physical storage media based on the type of data.

7. The method of claim 6, wherein the recommendation for reducing physical storage is further based on an identification of the physical storage.

8. The method of claim 1, further comprising:
graphically presenting, by the data management computer program, the physical storage used versus an allocated amount of physical storage.

9. The method of claim 1, further comprising:
graphically presenting, by the data management computer program, the relationships between data objects as a dependency graph.

10. A system, comprising:
a physical storage media storing an allocation of data; and
an electronic device executing a data management computer program that retrieves metadata for the allocation of data to a physical storage media, determines an amount of physical storage used from the metadata, identifying relationships between data objects in the data by parsing SQL statements directed towards the data objects in the allocation of data, generates a dependency graph using the relationships between data objects, identifies data to be removed as part of a data archival process; analyzes an impact of the data to be removed on the relationships using the dependency graph provides a recommendation for reducing physical storage based on the amount of physical storage used, an amount of physical storage allocated, and the impact of the data to be removed, graphically presenting the physical storage used versus an allocated amount of physical storage and the relationships between data objects using the dependency graph, and presenting a visualization of the impact of the data to be removed

11. The system of claim 10, wherein the data management computer program further determines a storage cost for the physical storage used to store the data using a cost overlay, and the recommendation for reducing physical storage is further based on the storage cost.

12. The system of claim 11, wherein the cost overlay identifies storage costs for different storage capabilities.

13. The system of claim 10, wherein the data management computer program further determines a time to recover the data on the physical storage media, wherein the time to recover is based on a volume of data on the physical storage media, network speeds and a read speed and a write speed of the physical storage media.

14. The system of claim 10, wherein the data management computer program further determines a type of data on the physical storage media and identifies data in the allocation of data on the physical storage media to move off of the physical storage media based on the type of data.

15. The system of claim 14, wherein the recommendation for reducing physical storage is further based on an identification of the data to move off the physical storage.

16. The system of claim 10, wherein the data management computer program further graphically presents the physical storage used versus an allocated amount of physical storage.

17. The system of claim 10, wherein the data management computer program further graphically presents the relationships between data objects as a dependency graph.

18. A non-transitory computer readable storage medium, including instructions stored thereon, which when read and executed by one or more computer processors, cause the one or more computer processors to perform steps comprising:
retrieving metadata for an allocation of data to a physical storage media;
determining, based on the metadata, an amount of physical storage used;
identifying relationships between data objects in the data by parsing SQL statements directed towards the data objects in the allocation of data;
generating a dependency graph using the relationships between data objects;
identifying data to be removed as part of a data archival process;
analyzing an impact of the data to be removed on the relationships using the dependency graph;
providing a recommendation for reducing physical storage based on the amount of physical storage used, an amount of physical storage allocated, and the impact of the data to be removed;
graphically presenting the physical storage used versus an allocated amount of physical storage and the relationships between data objects using the dependency graph; and
presenting a visualization of the impact of the data to be removed.

19. The non-transitory computer readable storage medium of claim 18, further including instructions stored thereon, which when read and executed by one or more computer processors, cause the one or more computer processors to perform steps comprising:
determining a storage cost for the physical storage used to store the data, wherein the recommendation for reducing physical storage is further based on the storage cost.

20. The non-transitory computer readable storage medium of claim 18, further including instructions stored thereon, which when read and executed by one or more computer processors, cause the one or more computer processors to perform steps comprising:
determining a type of data on the physical storage media; and
identifying data in the allocation of data on the physical storage media to move off of the physical storage media based on the type of data, wherein the recommendation for reducing physical storage is further based on an identification of the data to move off the physical storage.
